(19) United States
(12) Patent Application Publication
(10) Pub. No.: US 2014/0289016 A1
(43) Pub. Date: Sep. 25, 2014

(54) ENHANCEMENT OF ROOT CAUSE ANALYSIS OF CONSUMER FEEDBACK USING MICRO-SURVEYS AND APPLICATIONS THEREOF

(71) Applicants: M. Christopher Muto, Wayland, MA (US); Joseph D. Tagliente, Weston, MA (US); Joseph M. Tagliente, Weston, MA (US)

(72) Inventors: M. Christopher Muto, Wayland, MA (US); Joseph D. Tagliente, Weston, MA (US); Joseph M. Tagliente, Weston, MA (US)

(73) Assignee: GOPINION, INC., Weston, MA (US)

(21) Appl. No.: 14/221,257

(22) Filed: Mar. 20, 2014

Related U.S. Application Data
(60) Provisional application No. 61/803,676, filed on Mar. 20, 2013.

(51) Int. Cl. G06Q 30/02

(52) U.S. Cl. CPC G06Q 30/0203
USPC 705/7.32

(57) ABSTRACT

The present invention provides tools and methods that offer significant enhancement in consumer compliance in completing surveys, and afford statistically significant/accurate measurements of consumer feedback. In particular, the present invention provides software applications that utilize the methods described herein to administer Micro-Surveys to consumers, eliciting statistically significant feedback to effect global positive commercial change. Moreover, the present further provides a survey tool that utilizes a novel consumer propensity weighted analysis.

### RELATED APPLICATIONS

This application is a U.S. Utility application that claims the benefit of priority from U.S. Provisional Patent Application No. 61/803,676, filed on Mar. 20, 2013, the entirety of which is incorporated herein by reference.

### BACKGROUND OF THE INVENTION

It is well known that consumer feedback is critical for product and service industries. Such information is often obtained using surveys. Often these surveys are conducted person to person, either live or telephonically. Surveys are also conducted using survey cards. However, more recently, mobile device surveys have become an increasingly popular tool to attempt to achieve a similar goal.

Even with this most convenient recent option, consumer compliance in completing these surveys falls very short. As a general principle, it has been very difficult to capture useful commercially relevant information from consumers using surveys to assess their opinion. Accordingly, without consumer compliance in completing these surveys, the data obtained from such sources very little significance; and is therefore of very little use in root cause analysis of negative consumer feedback. And in the end, all that has been accomplished is the loss of time and money to conduct the surveys.

As such, there is a need to find new tools and methods of increasing consumer compliance with surveys, and/or methods of analyzing data to offer greater significance to the data actually obtained from a survey.

### SUMMARY OF THE INVENTION

The present invention provides tools and methods that offer significant enhancement in consumer compliance in completing surveys, and afford statistically significant/accurate measurements of consumer feedback, e.g., constructive feedback. Improving the statistical significance of consumer feedback affords enhancement of the analysis of consumer feedback with a greater ability to determine the root cause of negative consumer feedback. In particular, the present invention provides software applications, e.g., mobile applications that utilize the methods described herein, to administer Micro-Surveys to consumers, eliciting statistically significant feedback to effect global positive commercial change. The present application further provides a survey tool that accounts for the propensity of the consumer to provide positive or negative feedback and accounting for such trending in providing the same or opposite consumer feedback.

Accordingly, in one aspect the invention provides a method of identifying the root cause of negative consumer feedback comprising the steps of establishment of a user profile on a network; initiation of an interface by a consumer of user goods or services; administration of a Micro-Survey to the consumer to obtain answers to the questions of the Micro-Survey after the initiation by the consumer, wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions; storage of said user associated answers of the consumer in a consumer profile on the network; combination of said answers from said consumer profile with each additional user associated answer from each additional consumer to establish a total user data set; storage of said total user data set in the user profile; application of statistical analysis to the total user data set to identify the root cause of negative feedback; and outputting a root cause of the negative consumer feedback based on the final user data set and storage of the root cause in the user profile, such that the root cause of the negative feedback is identified.

In another aspect, the invention provides a method of consumer propensity (CP) weighted survey analysis comprising the steps of: administration of a survey to a plurality of consumers of goods or services to obtain answers to the questions of the survey; and statistical analysis of said answers, wherein the statistical analysis is calculated by using the following formula:

$${\sum }_{i = 0}^{r} {R}_{i} - {\sum }_{i = 0}^{n} {N}_{i}$$

wherein for each consumer a consumer recommendation factor (CRF) is calculated as the number of positive answers divided by the total number of Micro-Surveys completed for each consumer a consumer negativity factor (CNF) is calculated using the equation: 1-CRF; R is the set of CNFs of r users who submitted positive answers, and Rᵢ is the CNF of the i^{th} member in set R; and N is the set of CRF's of n users who submitted negative answers, and Nᵢ is the CRF of the i^{th} member in set N.

In another aspect, the invention provides a consumer survey tool comprising a machine readable medium having instructions stored thereon for execution by a processor to perform a method comprising the steps of establishment of a user profile on a network; initiation of an interface by a consumer of user goods or services; administration of a Micro-Survey to the consumer to obtain answers to the questions of the Micro-Survey after the initiation by the consumer, wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions; storage of said user associated answers of the consumer in a consumer profile on the network; combination of said answers from said consumer profile with each additional user associated answer from each additional consumer to establish a total user data set; storage of said total user data set in the user profile; application of statistical analysis to the total user data set to identify the root cause of negative feedback; and outputting a root cause of the negative consumer feedback based on the final user data set and storage of the root cause in the user profile, such that the root cause of the negative feedback is identified.

In yet another aspect, the invention provides a consumer survey tool employing consumer propensity (CP) weighted analysis comprising a machine readable medium having instructions stored thereon for execution by a processor to perform a method comprising the steps of: administration of a survey to a plurality of consumers of goods or services to obtain answers to the questions of the survey; and statistical analysis of said answers, wherein the statistical analysis is calculated by using the following formula:

$${\sum }_{i = 0}^{r} {R}_{i} - {\sum }_{i = 0}^{n} {N}_{i}$$

wherein for each consumer a consumer recommendation factor (CRF) is calculated as the number of positive answers divided by the total number of Micro-Surveys completed for each consumer a consumer negativity factor (CNF) is calculated using the equation: 1-CRF; R is the set of CNFs of r users who submitted positive answers, and Rᵢ is the CNF of the i^{th} member in set R; and N is the set of CRF's of n users who submitted negative answers, and Nᵢ is the CRF of the i^{th} member in set N.

A further aspect of the invention provides a method of enhancing root cause analysis of negative consumer feedback by increasing consumer compliance comprising the step of administration of a Micro-Survey to a consumer to obtain answers to the questions of the Micro-Survey, wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions, such that consumer compliance is increased, and the root cause analysis is enhanced.

### BRIEF DESCRIPTION OF DRAWINGS

FIG. 1 depicts the flow diagram of the consumer feedback loop.

FIG. 2 depicts an example flow diagram for soliciting feedback from consumers through Micro-Surveys.

FIG. 3 depicts a flow diagram of a specific implementation of the methods and consumer survey tool of the present invention.

FIG. 4 depicts an example of a mobile application graphic user interface (GUI) that displays when launching an application on a smartphone.

FIG. 5 depicts an example of a mobile application graphic user interface (GUI) that displays options for consumer check-in using GPS, or scanning a readable code.

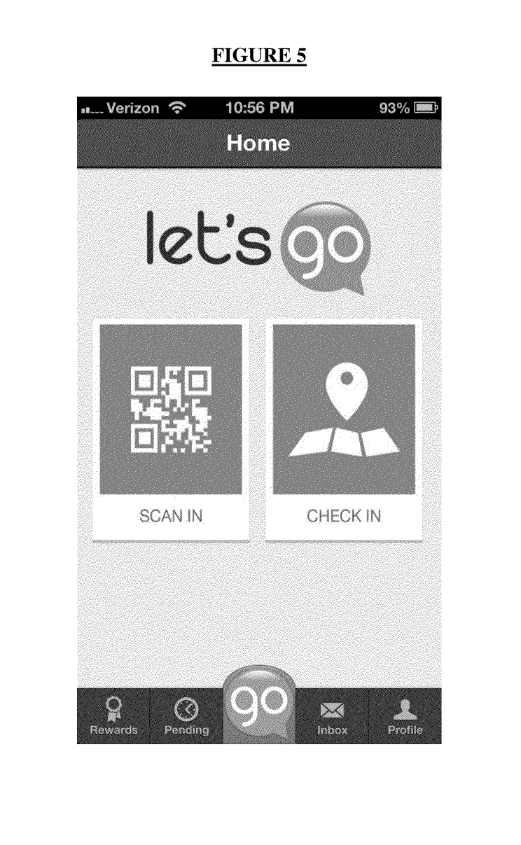

FIGS. 6A and 6B depict an examples of a mobile application graphic user interface (GUI) that demonstrates survey flow utilizing the unified question stream.

FIG. 7 depicts an example of a graphic user interface (GUI) offering a coupon, and displaying the time remaining for use.

FIGS. 8A and 8B depict an examples of a mobile application graphic user interface (GUI) that displays pending gopinions, or surveys.

FIGS. 9A and 9B depict an examples of a mobile application graphic user interface (GUI) that displays consumer profiles.

FIG. 10 depicts an example of a graphic user interface (GUI) displaying the invite friends tab.

FIG. 11 depicts an example of a graphic user interface (GUI) displaying the inbox.

FIG. 12 depicts an example of a graphic user interface (GUI) of a Home Page for the user.

FIG. 13 depicts an example of a graphic user interface (GUI) and process flow for the survey stream in the web app.

FIG. 14 depicts an example of a graphic user interface (GUI) of a page for storing and managing pending gopinions.

FIG. 15 depicts an example of a graphic user interface (GUI) of a page that displays consumer profiles.

FIG. 16 depicts an example of a graphic user interface (GUI) of a page for storing and managing rewards.

FIG. 17A depicts an example of a sample graphic user interface (GUI) of a Dashboard page. FIG. 17B is a screen capture of a graphic user interface (GUI) of a Dashboard page.

FIG. 18 is a screen capture of a graphic user interface (GUI) of the “Office Manager,” a box on the dashboard that allows the user to set their discount rates for each of the levels of user at their establishment.

### DETAILED DESCRIPTION OF THE INVENTION

The present invention provides tools and methods that offer significant enhancement in consumer compliance in completing surveys, and afford statistically significant/accurate measurements of consumer feedback, e.g., constructive feedback. In particular, the present invention provides software applications, e.g., mobile applications that utilize the methods described herein to administer Micro-Surveys to consumers, eliciting statistically significant feedback to effect global positive commercial change. The present further provides a survey tool that accounts for the propensity of the consumer to provide positive or negative feedback and accounting for such trending in providing the same or opposite consumer feedback.

The present invention, including novel tools, methods, applications, and related software will be described with reference to the following definitions that, for convenience, are set forth below. Unless otherwise specified, the below terms used herein are defined as follows:

### I. DEFINITIONS

As used herein, the term “a,” “an,” “the” and similar terms used in the context of the present invention (especially in the context of the claims) are to be construed to cover both the singular and plural unless otherwise indicated herein or clearly contradicted by the context.

The term “collecting” means the gathering of requested items, such as questions, or the gathering of items submitted without request. In certain embodiments, this act of collecting may involve offering suggestions of questions and receiving confirmation of that such suggestion is acceptable.

The term “consumer” is used herein to describes a person or entity that engages (e.g., purchases, obtains, or receives) goods or services for direct use or evaluation, i.e., as opposed for resale or use in production and manufacturing. It is the consumer, with respect to the present invention, that is presented the rewards in the reward systems of the present invention. As described herein, the term “consumers” includes all potential consumers as well as actual consumers, and those that would also serve as a marketing base (or polling source) to assist in marketing goods or services, e.g., post consumption consumers or pre-consumption consumers.

The language “consumer compliance,” as used herein describes the measure of a consumer presented with a survey to take and complete the survey. Accordingly, a consumer who takes and completes a survey presented to him/her has demonstrated consumer compliance, wherein such consumer compliance may be quantified for a given survey of a product or service. Moreover, the methods, tools, and software of the present invention, e.g., that utilize Micro-Surveys, provide an increase in overall consumer compliance as applied to the group of consumers presented with the surveys of the present invention.

The term “constructive” as used herein in the expression, “constructive consumer feedback describes feedback that may be used to assist in suggestion of positive change, e.g., commercial or noncommercial. In one embodiment, this constructive feedback may be negative, e.g., provide information related to a negative experience, such that a suggestion of avoiding actions taken during this negative experience could inform of a way to create a global positive commercial change. In another embodiment, this constructive feedback may be positive, e.g., provide information related to a positive experience, such that a suggestion of performing actions taken during this positive experience could inform of a way to create a global positive commercial change.

The term “feedback” is art-recognized, and describes the sentiment or opinion from a consumer based on experience with a product or service of a user

The language “goods or services” is used herein to describe the continuum of pure service at one endpoint and pure commodity goods at the other endpoint. In particular consumers of the present invention may consume a physical item or a good, an intangible service, or a combination of thereof. In general, goods are items that can be seen and touched, and services are provided by other people. In certain embodiments, a service includes professional services rendered to an individual. In certain embodiments, a service includes any service rendered to a group of two or more people (e.g., a locality), such as political service.

The term “indicating” describes the act of selecting, or “clicking” a displayed option in the graphic interface, for example, by touching the positive or negative response “button” with your finger on a touch sensitive screen (e.g., tapping or directionally sliding/swiping) or on a monitor with a pointing device used to actuate a feature using a button at the on-screen location of the pointer (e.g., a mouse pointer, often shown as an arrow).

The term “interfacing” as used herein, for example in the expression “interfacing with a user,” describes the means of communication between two entities/systems, for example the user and a network. In certain embodiments, the interfacing may be bi-directional. In other embodiments, the interfacing may be uni-directional. In particular embodiments, such interfacing may include receiving, confirming, rejecting, suggesting, proposing and/or assigning profile information or a question to a Micro-Survey.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network.

The term “Micro-Survey” describes binary surveys are intended to be completed by the ordinary consumer within one minute after survey is administered. Such surveys are intended to increase consumer compliance to improve the statistical significance of data obtained from a given survey, and as such afford a greater ability to determine the root cause of negative consumer feedback. Micro-Surveys, in certain embodiments, are administered via a mobile device, e.g., a mobile application, or via a computer, e.g., the internet. In one embodiment, a Micro-Survey comprises a unified question stream (UQS) to determine a root cause of negative consumer feedback with an initial set of 1 to 5 binary questions in root cause analysis format, optionally followed by a secondary set of 1 to 5, e.g., 1 to 3, e.g., 1 or 2 binary questions, in root cause format dynamically selected based upon identification of negative feedback for one of the answers by the consumer to said initial set of questions. In certain embodiments, the answers to these binary questions are either a positive indicator mark, for example a checkmark or a plus sign, or a negative indicator mark, for example an X sign or a minus sign and are answered by clicking, tapping, or directionally sliding/swiping said indicator.

The language “root cause analysis” describes a method of problem solving that tries to identify the root causes of faults or problems that cause operating events. Root cause analysis attempts to solve problems by attempting to identify and correct the root causes of events, as opposed to simply addressing their symptoms. By focusing correction on root causes, problem recurrence can be prevented or reduced.

The term “storing” means on storing on a network, or an array of networks, e.g., which are operably coupled to interact through a given interface.

The language “unified question stream” or “UQS,” which are used interchangeably herein to describe the question format for a series of questions in a survey that follow a particular information stream to determine the root cause of a particular problem. Moreover, in such a question stream, if a consumer does not identify an aspect of their experience as having a problem, it can be concluded that the Member was generally satisfied with that aspect of their experience. In contrast, other survey formats will ask for a consumer's general impression of every aspect of a product or experience.

The term “user” is used herein to describe any entity that desires to analyze consumer sentiment and interacts with the methods, tools, and applications of the present invention for that purpose. In certain embodiments, such users may include service providers. In certain embodiments, such users may include a provider of goods.

### II. MICRO-SURVEYS OF THE INVENTION

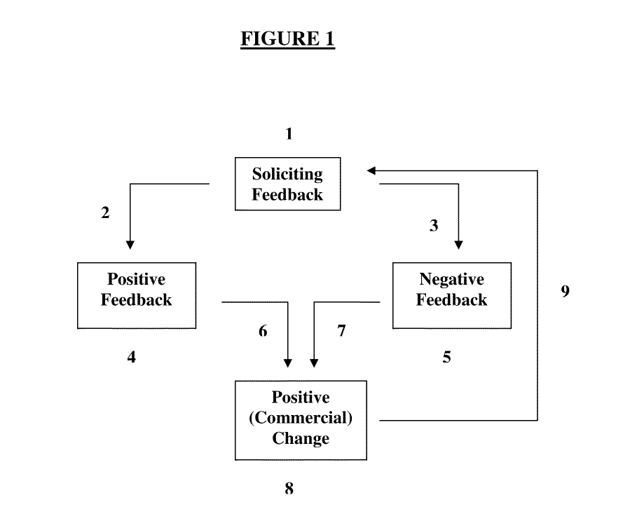

As shown in FIG. 1, generally, surveys are intended to solicit feedback 1 from consumers who have experienced the goods or services of a business. The act of evaluating these goods and services through surveys administered in 2 and 3, may lead to positive feedback 4, negative feedback 5, or a combination of both. This feedback is analyzed in 6 and 7, and ultimately leads to positive commercial change 8. For example, analysis of negative feedback 5 may lead to avoiding actions taken during this negative experience, or positive feedback 4 may lead to performing actions taken during this positive experience.

Ultimately, the positive commercial change 8 is tested through an iterative process by again soliciting feedback in 1.

However, without sufficient consumer compliance the data obtained has very little statistical significance. In particular, FIG. 1 demonstrates that without data to support significant positive or negative feedback pathways, appropriate positive commercial change cannot occur, or inappropriate, ill-characterized commercial change could occur.

Improving the statistical significance of consumer feedback affords enhancement of the analysis of consumer feedback with a greater ability to determine the root cause of negative consumer feedback, and make well-informed proper commercial decisions with respect to positive commercial change.

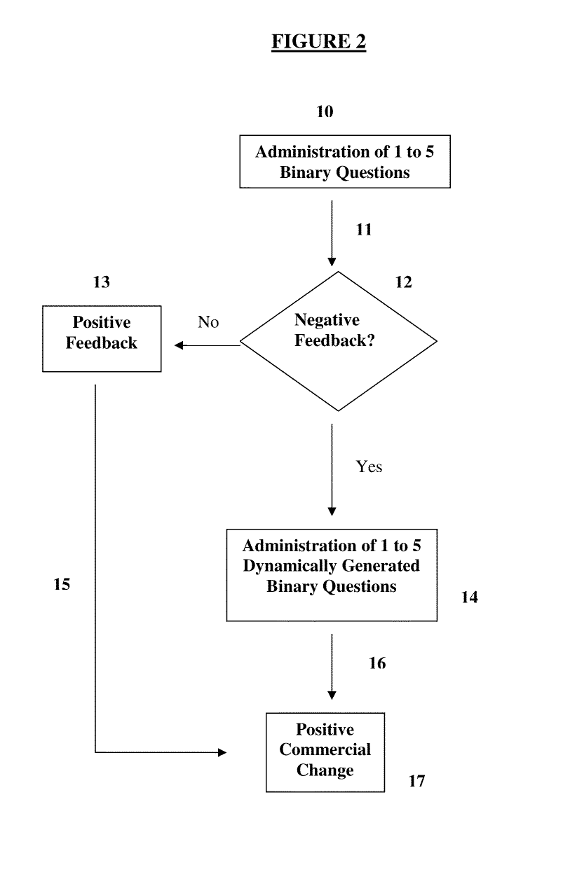

Accordingly, the present invention provides Micro-Surveys for use by entities desiring to analyze consumer sentiment, opinion, or feedback of consumers. These Micro-Surveys are designed to increase consumer compliance using binary questions structured in a unique manner. In particular, Micro-Surveys of the present invention use the design in FIG. 2 to solicit feedback from consumers, which serves to increase consumer compliance.

Micro-Surveys, in certain embodiments, are administered via a mobile device (e.g., a mobile application), or via a computer (e.g., the internet). In one embodiment, as in FIG. 2, a Micro-Survey begins with the administration to a consumer of an initial set of 1 to 5 binary questions 10 in root cause analysis format. The answers to these questions are provided by the consumer in 11, and an analysis of the negativity of the answer is made in 12. If an answer is positive 13, no additional questions are administered. If an answer is negative, a secondary set of 1 to 5 binary questions 14, e.g., 1 to 3, e.g., 1 or 2, in root cause format is dynamically generated and administered to the consumer based upon identification of the specific negative feedback for one of the answers by the consumer to the initial set of questions. This feedback is analyzed in 15 and 16, and ultimately leads to positive commercial change 17, wherein such change is based on data obtained from Micro-Surveys that produce enhanced consumer compliance. In certain embodiments questions in 10 and 14 are structured with a unified question stream (UQS) to determine a root cause of negative consumer feedback. In certain embodiments, the answers to these binary questions are either a positive indicator mark, for example a check mark or a plus sign, or a negative indicator mark, for example an X sign or a minus sign and are answered by clicking, tapping, or directionally sliding/swiping said indicator.

The objective of the Micro-Survey format is to have many people answer five questions quickly, rather than to have a few people answer many questions. The Micro-Survey questions are quick and easy to read/comprehend, and a consumer should be able to complete a single five-question survey (or section if they choose to complete more than one survey section) with a few smartphone taps or web browser clicks, and within a minute or less.

In one embodiment, the Micro-Surveys are written in a root cause analysis format. In this respect, whereas other survey formats will ask for a consumer's general impression of every aspect of a product or experience, the format of the Micro-Surveys of the present invention ask questions that will follow a particular information stream, or unified question stream (UQS) to determine the root cause of a problem. If a consumer does not identify an aspect of their experience as having a problem, it can be concluded that the consumer was generally satisfied with that aspect.

### III. METHODS OF THE INVENTION

In this respect, one embodiment of the invention provides a method of enhancing root cause analysis of negative consumer feedback by increasing consumer compliance. The method comprises the step of administration of a Micro-Survey to a consumer to obtain answers to the questions of the Micro-Survey (e.g., via mobile device or computer), wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions, such that consumer compliance is increased, and the root cause analysis is enhanced. In certain embodiments, the enhancement is due to a factor selected from the group consisting of increased consumer participation, increased root cause analysis accuracy, increased statistical significance of root cause, and increased consumer compliance.

Another embodiment of the invention provides a method of identifying the root cause of negative consumer feedback. The method comprises the steps of
establishment of a user profile on a first network;
initiation of an interface by a consumer of user goods or services;
administration of a Micro-Survey to the consumer to obtain answers to the questions of the Micro-Survey (e.g., via mobile device or computer) after the initiation by the consumer, wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions;
storage of said user associated answers of the consumer in a consumer profile on a second network;
combination of said answers from said consumer profile with each additional user associated answer from each additional consumer to establish a total user data set;
storage of said total user data set in the user profile;
application of statistical analysis to the total user data set to identify the root cause of negative feedback; and
outputting a root cause of the negative consumer feedback based on the final user data set and storage of the root cause in the user profile, such that the root cause of the negative feedback is identified. In certain embodiments, the second network is the same as the first network.

In certain embodiments of the invention, the establishment of a user profile comprises the steps of
interfacing with a user over a network;
collecting binary question from said user directed to consumer feedback;
storing said binary questions on the network; and
selecting one, two, three, four or five of said stored questions to create the Micro-Survey from said questions. In particular embodiments, five of the stored questions are used to create the Micro-Survey. In a specific embodiment, the interfacing with a user over a network is accomplished by using the internet over a mobile device. In another specific embodiment, the interfacing with a user over a network is accomplished by using the internet over a computer. In certain embodiments, the initiation of the interface by the consumer is accomplished by launching an application on a smartphone.

In certain embodiments of the invention where the initiation of the interface by the consumer is accomplished by launching an application on a smartphone, the smartphone application requests input of a readable code scan (e.g., QR code) or an alphanumeric code. The readable code scan or alphanumeric code input may also identify the geographic location of the consumer. Alternatively, the GPS in the smartphone may identify the geographic location of the consumer. In certain embodiments, the readable code for scanning is located at the bottom of the consumer receipt, folio or invoice for goods or services of the user.

The act by the consumer of scanning the readable code may administer the Micro-Survey for said user to the consumer.

In certain embodiments, the binary questions are answered by indicating a + symbol for a positive response or a − symbol for a negative response based on the consumer experience with the goods or services of the user.

In certain embodiments, the binary questions are answered by indicating a checkmark symbol for a positive response or an X symbol for a negative response based on the consumer experience with the goods or services of the user.

In certain embodiments, the method may further comprise the step of requesting additional comment, wherein the request is optional for the consumer to answer.

Certain embodiments of the method of identifying the root cause of negative consumer feedback further comprise the step of offering a reward for answering all the questions of the Micro-Survey, wherein such reward would be selected and stored in the profile of the consumer. The reward may be the product or services of the user, or the product or services of another user, e.g., a sponsor of the website. In certain embodiments, the reward may be based on how many Micro-Surveys a consumer has completed, e.g., over a designated period of time (e.g., one Micro-Survey may be a tier I, two Micro-Surveys may be a tier II, or three Micro-Survey may be a tier III, etc., and a schedule of when these must occur may also affect the reward, such as over consecutive days). In certain embodiments, the reward is selected from the group consisting of promotional items, coupons, rebates, discounts, or special offerings on goods and/or services. Alternatively, the reward may be points that are eligible for accumulation and exchange an item selected from the group consisting of promotional items, coupons, rebates, discounts, or special offerings on goods and/or services.

In certain embodiments, rewards may be tiered to establish rewards of greater value being associated with a greater tier. In particular embodiments, achieving greater tiers may be obtained by accruing value related to the earned rewards, which, for example, may be managed using a point system established by exchanging one or more rewards for a given amount of accruable value, i.e., points. Additionally, certain point values may be associated with rewards offered by a secondary user, e.g., the network operator.

In another embodiment of the method of identifying the root cause of negative consumer feedback, the statistical analysis to the total user data set is based on the propensity of the consumer established in the consumer profiles. In one particular embodiment, more statistical significance is given to consumer profiles that do not provide negative feedback greater than 50% of the time. In another particular embodiment, less statistical significance is given to consumer profiles that provide negative feedback greater than 50% of the time. In yet a further particular embodiment, the statistical analysis is performed by using the following formula:

$${\sum }_{i = 0}^{r} {R}_{i} - {\sum }_{i = 0}^{n} {N}_{i}$$

wherein

for each consumer a consumer recommendation factor (CRF) is calculated as the number of positive answers divided by the total number of Micro-Surveys completed;

for each consumer a consumer negativity factor (CNF) is calculated using the equation: 1-CRF;

R is the set of CNFs of r users who submitted positive answers, and Rᵢ is the CNF of the i^{th} member in set R; and

N is the set of CRF's of n users who submitted negative answers, and Nᵢ is the CRF of the i^{th} member in set N. The result of the statistical analysis may be used as calculated or manipulated to provide a more consumer/user usable value, e.g., as a percentage.

Alternatively, in another embodiment of the method of identifying the root cause of negative consumer feedback, the statistical analysis to the total user data set is based on consumer segment survey analysis, wherein users are compared to other businesses/users in their market, or consumer segment. In one particular embodiment, the consumer segment survey analysis is performed by using the following formula to establish the percentage, P, of stores that have a lower raw rating than the user:

P=100*(N₁/N_{Tot})

wherein

N₁ is number of raw ratings that are less than the raw rating of user;

N_{Tot} is the total number of raw ratings in the consumer segment; and

the raw rating of a user is determined by the number of positive ratings for a certain question for that user divided by the total number of ratings for the user. In certain embodiments, N_{Tot} is greater than or equal to 10.

In certain embodiments, the ability to identify the root cause of negative consumer feedback is enhanced. For example, the enhancement may be due to a factor selected from the group consisting of increased consumer participation, increased root cause analysis accuracy, increased statistical significance of root cause, and increased consumer compliance.

### Statistical Analysis Based on Consumer Conduct

In one embodiment of the invention, the statistical analysis of the data from the Micro-Surveys of the present invention serves to obtain a statistically significant value from binary questions. In certain embodiments, to do so may require comparing the responses and businesses/users to each other. Two such methods include, but are not limited to consumer propensity weighted survey analysis and consumer segment survey analysis, each stemming from a different primary assumption of consumer conduct.

Moreover, although each may be applied individually, in certain embodiments, the consumer propensity weighted survey analysis may be combined with the consumer segment survey analysis.

A. Consumer Propensity Weighted Survey Analysis

In certain embodiments, the primary assumption would consider that a consumer, regardless of what establishment they are at, will rate positively or negatively at the same rate that they have in the past. As such, in another embodiment, the present invention relates to a novel method of survey analysis that is applicable to any type of survey. Accordingly, the present invention provides a method of consumer propensity (CP) weighted survey analysis. The method comprises the steps of:
administration of a survey to a plurality of consumers of goods or services to obtain answers to the questions of the survey; and
statistical analysis of said answers, wherein the statistical analysis is calculated by using the following formula:

$${\sum }_{i = 0}^{r} {R}_{i} - {\sum }_{i = 0}^{n} {N}_{i}$$

wherein

for each consumer a consumer recommendation factor (CRF) is calculated as the number of positive answers divided by the total number of Micro-Surveys completed;

for each consumer a consumer negativity factor (CNF) is calculated using the equation: 1-CRF;

R is the set of CNFs of r users who submitted positive answers, and Rᵢ is the CNF of the i^{th} member in set R; and

N is the set of CRF's of n users who submitted negative answers, and Nᵢ is the CRF of the i^{th} member in set N.

In certain embodiments, the survey comprises binary questions. In a particular embodiment, the survey is a Micro-Survey. In a specific embodiment, the Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions.

In certain embodiments, consumer propensity weighted survey analysis may be used when considering data for larger regions where populations are less overlapping.

This analysis may be used to calculate a rating score, e.g., that may be featured in an interface with a user. This rating could give the user a useful “at-a-glance” performance number based on consumer propensity. An example of using the CP weighted survey analysis

$${\sum }_{i = 0}^{r} {R}_{i} - {\sum }_{i = 0}^{n} {N}_{i}$$

may be found in Table 1 below.

TABLE 1

| User Number | Recommended? | CRF (CNF) |
|---|---|---|
| 1 | Y | .93 (.07) |
| 2 | N | .51 (.49) |
| 3 | Y | .71 (.29) |
| 4 | N | .98 (.02) |
| 5 | Y | .15 (.85) |

Rating = .07 − .51 + .29 − .98 + .85 = −.28

B. Consumer Segment Survey Analysis

In certain embodiments, the primary assumption that if you analyze a small enough area, and compare stores within the same market, e.g., a micro-market, the population of people rating those stores are basically the same. This would means that the consumer propensity is taken out of the equation because we assume that we are looking at a similar enough subset of raters that all that matters is the relative rates of positive responses between businesses. As such, in another embodiment, the present invention relates to a novel method of survey analysis that is applicable to any type of survey. Accordingly, the present invention provides a method of consumer segment (CS) survey analysis. The method comprises the steps of:
administration of a survey to a plurality of consumers of goods or services to obtain answers to the questions of the survey; and
statistical analysis of said answers, wherein the statistical analysis is calculated by using the following formula:

P=100*(Nᵢ/N_{Tot})

wherein

P is the percentage of stores that have a lower raw rating than the user;

N₁ is number of raw ratings that are less than the raw rating of user;

N_{Tot} is the total number of raw ratings in the consumer segment; and

the raw rating of a user is determined by the number of positive ratings for a certain question for that user divided by the total number of ratings for the user. In certain embodiments, N_{Tot} is greater than or equal to 10. In particular embodiments, the method further comprises the step of checking for comparable users within a 20-mile radius, and increasing the size of the radius until at least 10 comparable stores are found. As such, as more users participate in the surveys, the comparison radii will decrease, and the ability of the users see how they are performing against their direct competition will increase.

In certain embodiments, the survey comprises binary questions. In a particular embodiment, the survey is a Micro-Survey. In a specific embodiment, the Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions.

In certain embodiments, the CS survey analysis may be used to increase the calculation speed for analysis.

This analysis may be used to calculate a rating score, e.g., that may be featured in an interface with a user. This rating could give the user a useful “at-a-glance” performance number based on consumer propensity. An example of using the consumer segment survey analysis

P=100*(Nᵢ/N_{Tot})

may be found in Table 2 below.

TABLE 2

| Store | |
|---|---|
| Number | Store Raw Rating |
| 1 | 84% |
| 2 | 87% |
| 3 | 71% |
| 4 | 81% |
| 5 | 91% |
| 6 | 81% |
| 7 | 80% |
| 8 | 83% |

Store 1 rating = 84%
N₁ = 5
N_{Tot} = 7
P = 100 * (N₁/N_{Tot}) = 100 * (5/7) = 71.4%

### IV. APPLICATIONS

A. General

The methods of the invention may be implemented in any manner that achieves the intended purpose of the methods. However, in one embodiment, the methods of the invention may be implemented using software applications (e.g., via mobile devices such as smartphones or tablets, or via a desktop application) or via the internet.

As such, in one embodiment of the invention, the present invention provides a consumer survey tool comprising a machine readable medium having instructions stored thereon for execution by a processor to perform a method comprising the steps of
establishment of a user profile on a first network;
initiation of an interface by a consumer of user goods or services;
administration of a Micro-Survey to the consumer to obtain answers to the questions of the Micro-Survey (e.g., via mobile device or computer) after the initiation by the consumer, wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions;
storage of said user associated answers of the consumer in a consumer profile on a second network;
combination of said answers from said consumer profile with each additional user associated answer from each additional consumer to establish a total user data set;
storage of said total user data set in the user profile; application of statistical analysis to the total user data set to identify the root cause of negative feedback; and
outputting a root cause of the negative consumer feedback based on the final user data set and storage of the root cause in the user profile, such that the root cause of the negative feedback is identified. In certain embodiments, the second network is the same as the first network.

In certain embodiments of the invention, the establishment of a user profile comprises the steps of
interfacing with a user over a network;
collecting binary question from said user directed to consumer feedback;
storing said binary questions on the network; and
selecting one, two, three, four or five of said stored questions to create the Micro-Survey from said questions. In particular embodiments, five of the stored questions are used to create the Micro-Survey. In a specific embodiment, the interfacing with a user over a network is accomplished by using the internet over a mobile device. In another specific embodiment, the interfacing with a user over a network is accomplished by using the internet over a computer. In certain embodiments, the initiation of the interface by the consumer is accomplished by launching an application on a smartphone.

In certain embodiments of the invention where the initiation of the interface by the consumer is accomplished by launching an application on a smartphone, the smartphone application requests input of a readable code scan (e.g., QR code) or an alphanumeric code. The readable code scan or alphanumeric code input may also identify the geographic location of the consumer. Alternatively, the GPS in the smartphone may identify the geographic location of the consumer. In certain embodiments, the readable code for scanning is located at the bottom of the consumer receipt, folio or invoice for goods or services of the user.

The act by the consumer of scanning the readable code may administer the Micro-Survey for said user to the consumer.

In certain embodiments, the binary questions are answered by indicating a + symbol for a positive response or a − symbol for a negative response based on the consumer experience with the goods or services of the user.

In certain embodiments, the binary questions are answered by indicating a checkmark symbol for a positive response or an X symbol for a negative response based on the consumer experience with the goods or services of the user.

In certain embodiments, the method may further comprise the step of requesting additional comment, wherein the request is optional for the consumer to answer.

Certain embodiments of the method of identifying the root cause of negative consumer feedback further comprise the step of offering a reward for answering all the questions of the Micro-Survey, wherein such reward would be selected and stored in the profile of the consumer. The reward may be the product or services of the user, or the product or services of another user, e.g., a sponsor of the website. In certain embodiments, the reward may be based on how many Micro-Surveys a consumer has completed, e.g., over a designated period of time (e.g., one Micro-Survey may be a tier I, two Micro-Surveys may be a tier II, or three Micro-Survey may be a tier III, etc., and a schedule of when these must occur may also affect the reward, such as over consecutive days). In certain embodiments, the reward is selected from the group consisting of promotional items, coupons, rebates, discounts, or special offerings on goods and/or services. Alternatively, the reward may be points that are eligible for accumulation and exchange an item selected from the group consisting of promotional items, coupons, rebates, discounts, or special offerings on goods and/or services.

In another embodiment, the statistical analysis to the total user data set is based on the propensity of the consumer established in the consumer profiles. In one particular embodiment, more statistical significance is given to consumer profiles that do not provide negative feedback greater than 50% of the time. In another particular embodiment, less statistical significance is given to consumer profiles that provide negative feedback greater than 50% of the time. In yet a further embodiment, the statistical analysis is performed by using the following formula:

$${\sum }_{i = 0}^{r} {R}_{i} - {\sum }_{i = 0}^{n} {N}_{i}$$

wherein

for each consumer a consumer recommendation factor (CRF) is calculated as the number of positive answers divided by the total number of Micro-Surveys completed;

for each consumer a consumer negativity factor (CNF) is calculated using the equation: 1-CRF;

R is the set of CNFs of r users who submitted positive answers, and Rᵢ is the CNF of the i^{th} member in set R; and

N is the set of CRF's of n users who submitted negative answers, and Nᵢ is the CRF of the i^{th} member in set N. The result of the statistical analysis may be used as calculated or manipulated to provide a more consumer/user usable value, e.g., as a percentage.

In certain embodiments, the ability to identify the root cause of negative consumer feedback is enhanced. For example, the enhancement may be due to a factor selected from the group consisting of increased consumer participation, increased root cause analysis accuracy, increased statistical significance of root cause, and increased consumer compliance.

The machine-readable media described herein may be selected from the group consisting of magnetic media, punched cards, paper tapes, optical disks, barcodes, magnetic ink characters, and solid state devices (e.g., flash-based, SSD, etc.). For example, in a particular embodiment, the machine-readable medium is a solid state device. In certain embodiments, the machine-readable medium is selected from the group consisting of magnetic media, optical disks, and solid state devices.

Moreover, the instructions stored on the machine-readable medium may be implemented by online software or offline software. In certain embodiments, the instructions stored on the machine-readable medium are online software. In certain embodiments, the software is an online application, e.g., a web-based application or a cloud-based application. In certain embodiments, the software is an offline application, e.g., Software as a Service (SaaS). For example, desktop software may interact directly with internet server (e.g., without the need for a browser such as the world wide web)

In certain embodiments, the instructions stored on the machine-readable medium are mobile application software.

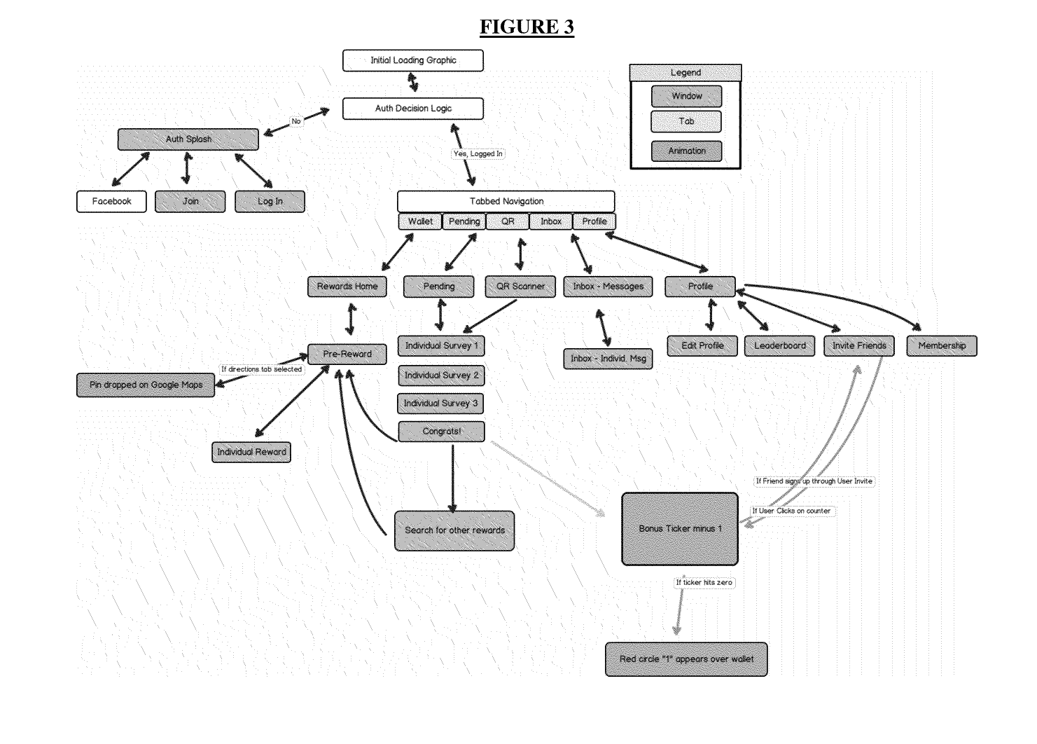

For example, FIG. 3 depicts a flow diagram of a specific implementation of the methods and consumer survey tool of the present invention, e.g., web-based or mobile device applications.

As indicated in FIG. 3, upon logging into the application, the authorization logic decides if the member/consumer is logged in or not to the member/consumer profile. If the consumer is not, the consumer is brought to the login page. If the consumer is logged in, the consumer is brought to the home page of the application, that gives the consumer the option to GPS check in or QR code scan in to initiate a survey.

Upon initialization of a survey, the consumer is brought to the first set of questions for a user/business (Individual Survey 1). These questions include large, blanket questions (e.g. Service, Value etc.). Upon receiving the answers, the survey logic dynamically selects one of the negative answers the consumer gave and brings him or her to the second survey page which has a deeper set of sub-questions about the initial negatively rated question. If, for example, “Service” is rated negatively on the first page, the survey will bring up a group of sub-questions about the service in order to figure out exactly what went wrong.

If the consumer did not answer anything negatively on the first survey page, the consumer is brought to the “Market Research Page”, which is a set of questions that the user has created, but are in the same binary format.

After the second page is complete, the consumer is brought to an optional final comments page. There the consumer can add additional comments and name the person who helped them (whether a waiter or salesperson) during the experience they are rating.

Once the survey is submitted, the consumer is able to select a reward. The consumer is initially offered the reward from the user they just surveyed. If they do not want that reward, they may enter the reward store, in which they can select a reward from any of our non-competing affiliate merchants. The selected reward is placed in the consumer's wallet. When the consumer wants to redeem, they go to the pre-reward page that offers them directions to find a place to redeem the reward, and double checks that they want to activate the reward. Once a reward is activated, it remains active for a period of time, e.g., one hour, before disappearing from their mobile device.

The other way to initiate a survey is to visit the “Pending” tab. If a survey is initiated by either a scan or a GPS check-in, and the survey is not completed, it remains in the consumer's “Pending Gopinions” for a period of time, e.g., up to three days. After that period, it is removed and the consumer must re-initiate with a scan or GPS-check in.

The “Inbox” is where consumer can view messages sent to them from user. The inbox system allows users to contact certain consumer, whether to apologize or thank them for loyalty, and also allows them to attach a coupon.

The consumer's profile may include the elements:
1. Edit profile: Where the consumer can edit their profile information.
2. Leaderboard: Where the consumer can see how many Gopinions other members/consumers have submitted.
3. Membership: Where the consumer can see what level they have reached, and what level of rewards are available to them.
4. Invite friends: Where the consumer can invite friends to use Gopinion via Facebook, Twitter, SMS, or e-mail.

### Consumer Propensity Weighted Survey Analysis

In another embodiment, the present invention provides a consumer survey tool employing consumer propensity (CP) weighted analysis comprising a machine readable medium having instructions stored thereon for execution by a processor to perform a method comprising the steps of:
administration of a survey to a plurality of consumers of goods or services to obtain answers to the questions of the survey; and
statistical analysis of said answers, wherein the statistical analysis is calculated by using the following formula:

$${\sum }_{i = 0}^{r} {R}_{i} - {\sum }_{i = 0}^{n} {N}_{i}$$

wherein

for each consumer a consumer recommendation factor (CRF) is calculated as the number of positive answers divided by the total number of Micro-Surveys completed;

for each consumer a consumer negativity factor (CNF) is calculated using the equation: 1-CRF;

R is the set of CNFs of r users who submitted positive answers, and Rᵢ is the CNF of the i^{th} member in set R; and

N is the set of CRF's of n users who submitted negative answers, and Nᵢ is the CRF of the i^{th} member in set N.

In certain embodiments, the survey comprises binary questions. In a particular embodiment, the survey is a Micro-Survey. In a specific embodiment, the Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions.

The machine-readable media described herein may be selected from the group consisting of magnetic media, punched cards, paper tapes, optical disks, barcodes, magnetic ink characters, and solid state devices (e.g., flash-based, SSD, etc.). For example, in a particular embodiment, the machine-readable medium is a solid state device. In certain embodiments, the machine-readable medium is selected from the group consisting of magnetic media, optical disks, and solid state devices.

Moreover, the instructions stored on the machine-readable medium may be implemented by online software or offline software. In certain embodiments, the instructions stored on the machine-readable medium are online software. In certain embodiments, the software is an online application, e.g., a web-based application or a cloud-based application. In certain embodiments, the software is an offline application, e.g., Software as a Service (SaaS). For example, desktop software may interact directly with internet server (e.g., without the need for a browser such as the world wide web)

In certain embodiments, the instructions stored on the machine-readable medium are mobile application software.

### Consumer Segment Survey Analysis

In another embodiment, the present invention provides a consumer survey tool employing consumer segment (CS) survey analysis comprising a machine readable medium having instructions stored thereon for execution by a processor to perform a method comprising the steps of:
administration of a survey to a plurality of consumers of goods or services to obtain answers to the questions of the survey; and
statistical analysis of said answers, wherein the statistical analysis is calculated by using the following formula:

P=100*(Nᵢ/N_{Tot})

wherein

P is the percentage of stores that have a lower raw rating than the user;

N₁ is number of raw ratings that are less than the raw rating of user;

N_{Tot} is the total number of raw ratings in the consumer segment; and
the raw rating of a user is determined by the number of positive ratings for a certain question for that user divided by the total number of ratings for the user. In certain embodiments, N_{Tot} is greater than or equal to 10.

In certain embodiments, the survey comprises binary questions. In a particular embodiment, the survey is a Micro-Survey. In a specific embodiment, the Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions.

The machine-readable media described herein may be selected from the group consisting of magnetic media, punched cards, paper tapes, optical disks, barcodes, magnetic ink characters, and solid state devices (e.g., flash-based, SSD, etc.). For example, in a particular embodiment, the machine-readable medium is a solid state device. In certain embodiments, the machine-readable medium is selected from the group consisting of magnetic media, optical disks, and solid state devices.

Moreover, the instructions stored on the machine-readable medium may be implemented by online software or offline software. In certain embodiments, the instructions stored on the machine-readable medium are online software. In certain embodiments, the software is an online application, e.g., a web-based application or a cloud-based application. In certain embodiments, the software is an offline application, e.g., Software as a Service (SaaS). For example, desktop software may interact directly with internet server (e.g., without the need for a browser such as the world wide web)

In certain embodiments, the instructions stored on the machine-readable medium are mobile application software.

B. Specific Design Elements of the Micro-Survey: Gopinion Application

The ornamental appearance of any novel design provided herein is intended to be part of this invention, for example, each of the representations of the appearance of a desktop screenshot or mobile device application depicted in the following figures.

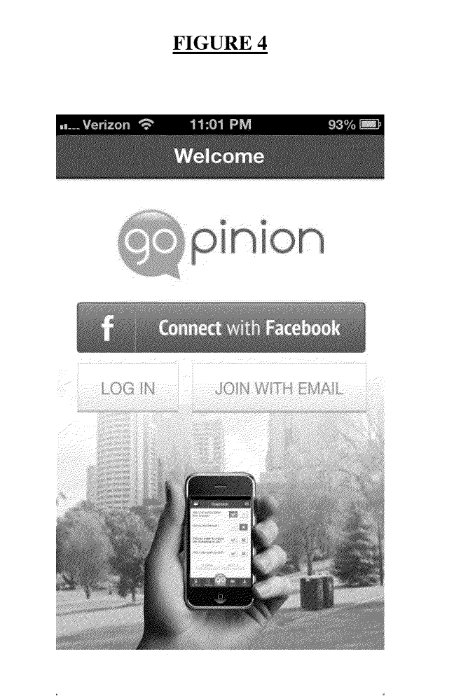

In a specific embodiment, for example FIG. 4, the consumer will initiate the process by launching an application on their smartphone, e.g., a Gopinion application.

In the Gopinion application, the consumer will check-in my GPS, or scan the readable code at the bottom of their receipt, folio or invoice which will bring up the survey or “Gopinion” for that user, e.g., merchant or service provider.

The opening question will prompt the consumer to grade each critical aspect of their experience based on a checkmark or an X mark where the checkmark represents a positive experience and the X mark represents a negative experience.

If the consumer indicate (tap/slides to) an X mark on one or more aspects on the opening page, it will take consumer to the next page; a dynamically generated specific aspect prompt page. If there is only one X mark, that will be the aspect chosen. If there were 2 or more negative ratings, the aspect will be randomly selected from one of their X selections. The consumers will then be asked again to indicate a checkmark or an X mark about the specific attributes of that aspect, e.g., 1 to 3 additional questions.

If the consumer rates all checkmark on the opening page (i.e., no complaints), the consumer will be brought to a “Market Research Page”, which is customizable by the user, e.g., the merchant. This can be used to ask 1 to 5, e.g., 1 to 3, e.g., 1 or 2 specific questions about their establishment, and/or can be used to alert customers to special deals; wherein each critical aspect of their experience is graded by the consumer again based on a checkmark or an X.

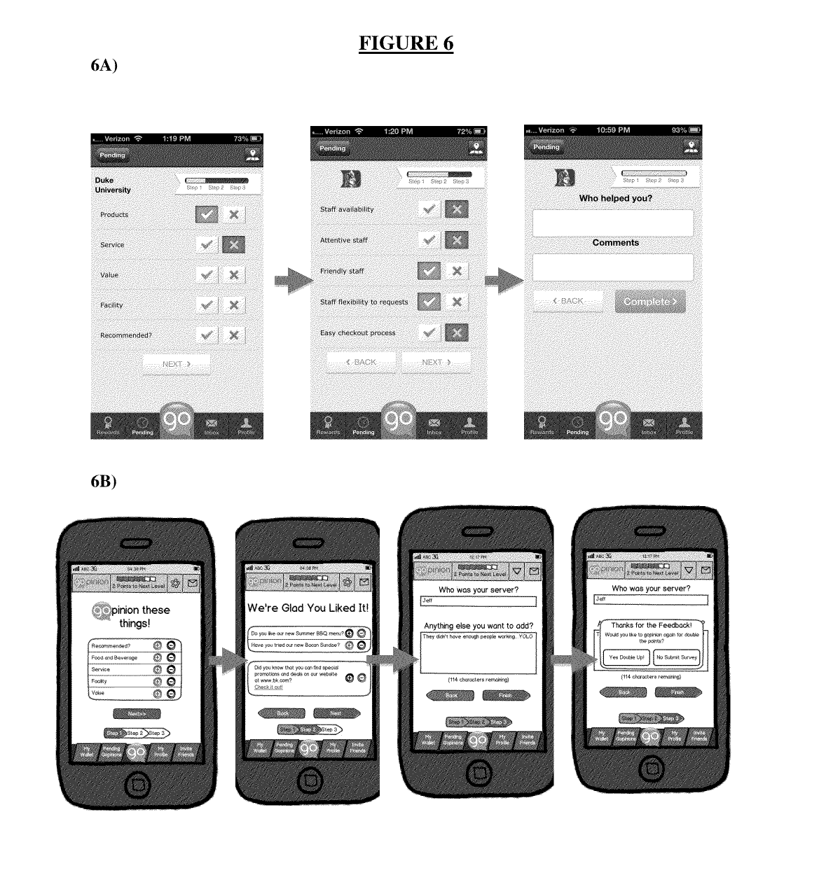

The survey will end with an optional “Additional Comments” screen. When the consumer finishes the survey, if they rated two or more things on the first page “−”, they will have the option to take a second survey about one of the other “−” rated categories. FIG. 6 shows examples of this survey flow utilizing the unified question stream. However, in certain embodiments, two surveys will be the maximum amount a consumer can take at one time. For example, in the case in FIG. 6B, clicking “Yes Double Up” would start a question stream about the “Facility.”

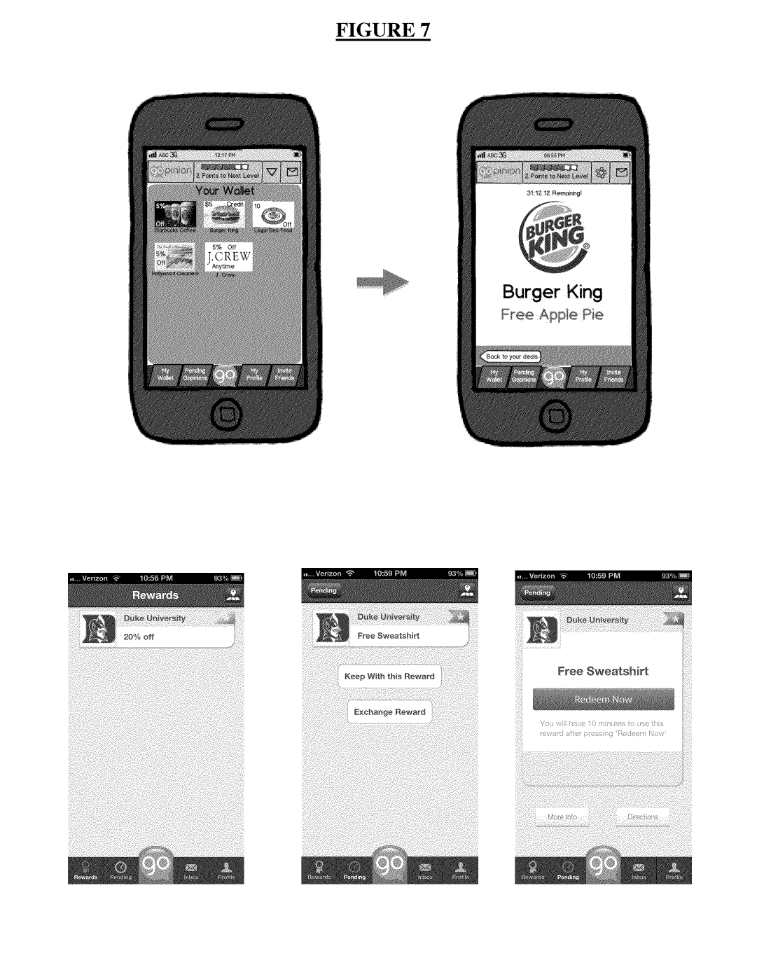

Submitting the survey then brings the consumer to the reward redeem page where the consumer can select gift cards to add to their “wallet,” for example, FIG. 7. Clicking on a gift card puts that card in your “wallet.”

However, certain components/elements of the Gopinion Application described herein are structured for the consumer, while certain components/elements are structured for the user.

In certain embodiments, every completed survey earns a reward. A selected gift card goes into the consumer's “wallet”, which can be accessed from the “My Wallet” tab. Clicking on a gift card brings the consumer to the coupon screen. The coupon will display what it is good for, and a timer at the top. After opening the coupon, the consumer will have a defined period of time, e.g., 1 hour, to use it before it disappears. Store employees will be instructed not to accept a gopinion coupon unless the timer at the top is moving. As soon as the coupon disappears, a notification will be sent to the merchant's/user's dashboard telling them what coupon was redeemed, and at what time it was redeemed.

In one embodiment, a consumer may accumulate, or “earn” points through the submission of Micro-Surveys and referrals. The consumer gets one point for each submission and one point for referring a friend who joins. In the level bar across the top each box is one point. If the point is earned through a survey, the box fills in one color (e.g., in the above example, green). If through a referral, it fills in another color (e.g., in the above example blue). Consumers are eligible to exchange points earned for promotional items consisting of coupons, rebates, discounts or special offerings on goods and/or service provided by web site sponsors.

In certain embodiments, the redeem page will have two sections, “Get a Deal Here” or “Get a Deal from Another Gopinion Venue”. The “Get a Deal Here” section will involve a deal that they can redeem either on the spot, or a larger deal they can redeem on a return visit. The “Get a Deal from Another Gopinion Venue” section will have featured deals, nearby deals, and a search function so that consumers can find the exact deal they want.

In one embodiment, a leveling scheme may be established based on the concept of greater levels of discount for consumers that use the application more. In certain embodiments, the reward may be based on how many Micro-Surveys a consumer has completed, e.g., over a designated period of time (e.g., one Micro-Survey may be a tier I, two Micro-Surveys may be a tier II, or three Micro-Survey may be a tier III, etc., and a schedule of when these must occur may also affect the reward, such as over consecutive days). Alternatively, Table 3 shows a sample leveling scheme, wherein EPs represents Earned Points.

TABLE 3

| | Accumulated EPs | | | Range of Offers |
|---|---|---|---|---|
| Levels | per Level | | Names of Levels | at Level |
| 1 | 0 to 9 | pts | New In Town | 2% to 5% discount |
| 2 | 10 to 49 | pts | Neighborhood Star | 4% to 7.5% |
| 3 | 50 to 99 | pts | Main Street Hero | 6% to 10% |
| 4 | 100 to 199 | pts | Local Legend | 8% to 12.5% |
| 5 | ≧200 | pts | City Champion | 10% to 15% |

i. Consumer Specific Elements

Certain elements of the Gopinion Application are structured for the consumer. In a mobile application there are a number of “buttons” that produce certain actions

### Consumer Facing Mobile App

The “GO” Button

The “go” button is on every page of the application, or app. Clicking this button always brings the consumer to the QR scanner.

“My Wallet”

This tab brings the consumer to a page listing the rewards they have earned. Clicking on a reward brings up the coupon bar code that can be scanned by the store.

“Pending Gopinions”

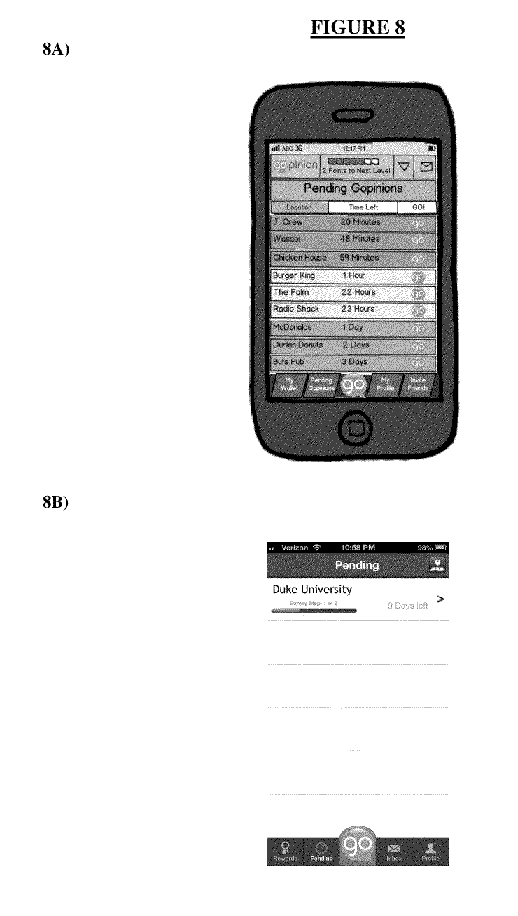

After the consumer scans the code on the receipt and is sent to the survey, if they have to exit before finishing, the survey is put into their “Pending Gopinions,” for example FIG. 8. The consumer then has a certain period of time, e.g., three days, to complete and submit the gopinion Micro-Survey in order to earn a reward, e.g., a point and/or a reward.

“My Profile”

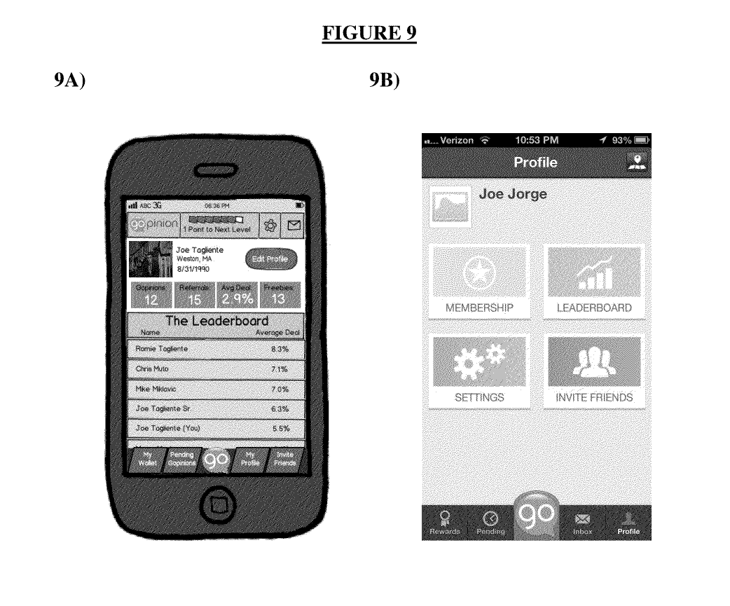

The profile, for example FIG. 9, allows the consumer to personalize their account, also giving the system demographic information for the surveys. This page will show a few stats, and allow the consumer to edit their profile and settings. It will also include a leaderboard that allows the consumer to see how much they are saving compared to their friends.

“Invite Friends”

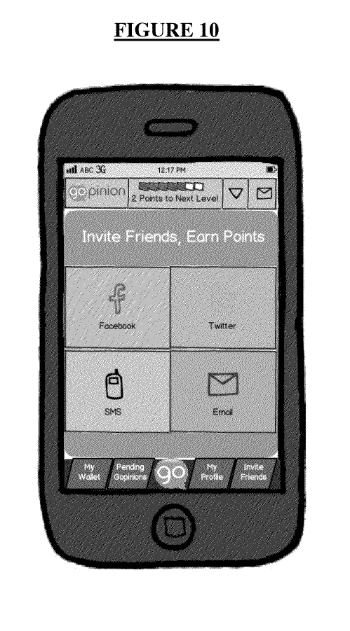

A simple tab, for example FIG. 10, that makes it very easy for people to invite their friends to use the Gopinion app, for points and/or rewards.

“Inbox”

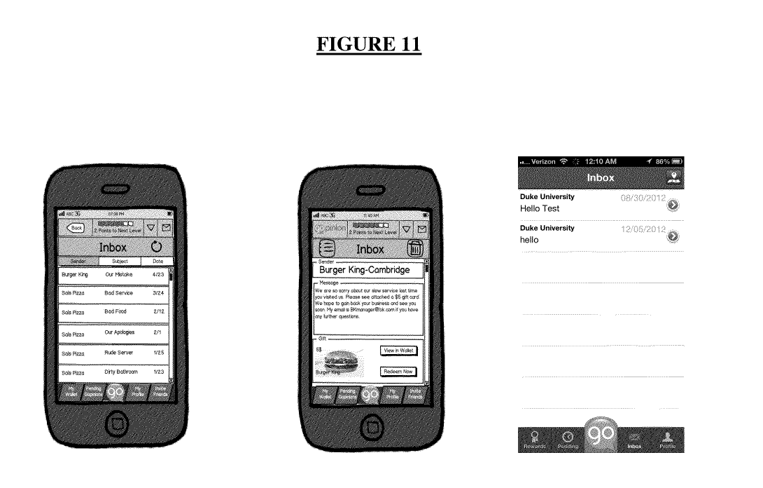

The inbox, for example, FIG. 11, is going to be an in-app messaging service that allows business operators to specifically respond to particularly bad gopinions (or particularly loyal consumers). Operators/Users can also send deals through the messages:

### Consumer Facing Web App

This app, with similar functionality to the mobile device based application, or app, does not requiring a consumer to have a smartphone. The consumer facing web app will be initiated by entering in an alphanumeric code to link to surveys instead of scanning them at the location.

Home Page

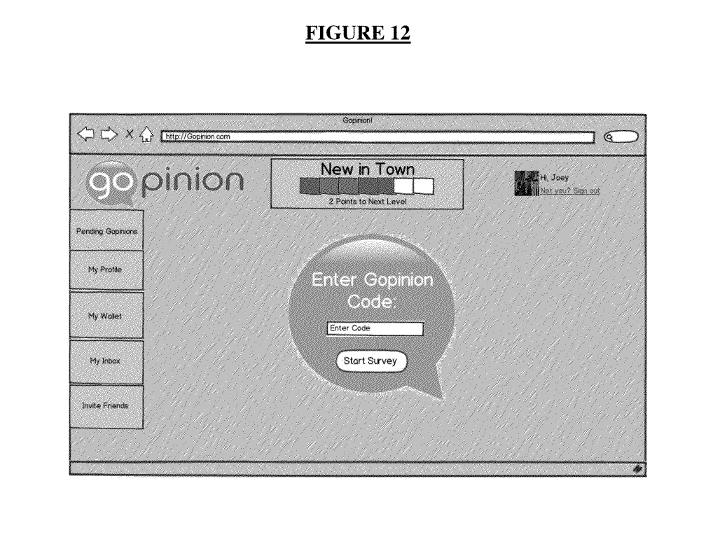

After logging in, the home page, for example FIG. 12, for the consumer will be a very simple, code input field where the consumer can enter in an alphanumeric code that corresponds to a purchase they made. Clicking the Gopinion logo in the top right will bring the consumer back to this screen from anywhere in the consumer's section:

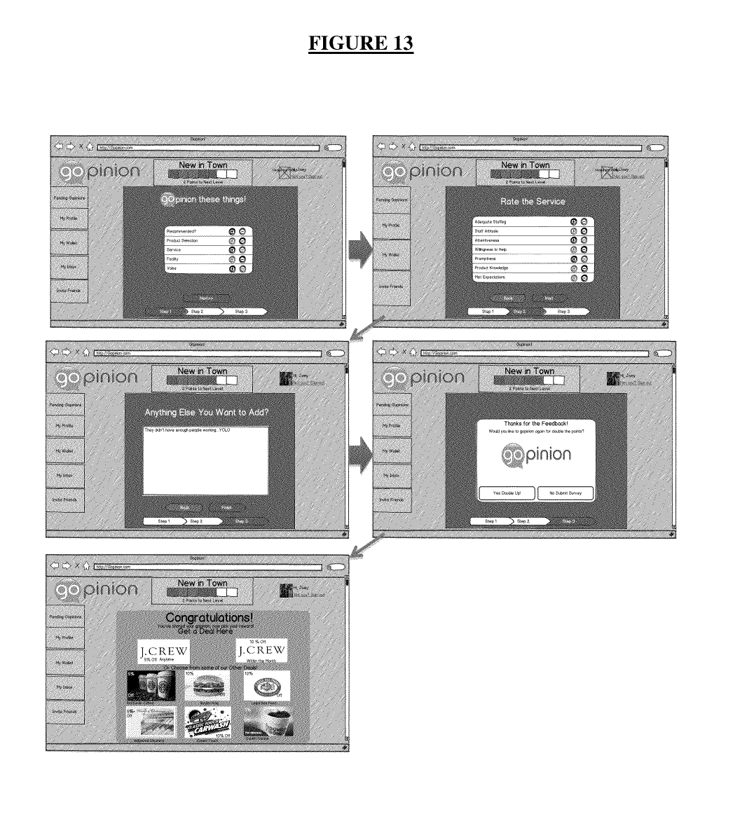

The survey stream, for example, FIG. 13, for the web app will be exactly the same as in the mobile app question stream. At the end it will take the user to a similar prize-redeem page:

The sidebar buttons/tabs are also similar to the mobile app.

Pending Gopinions

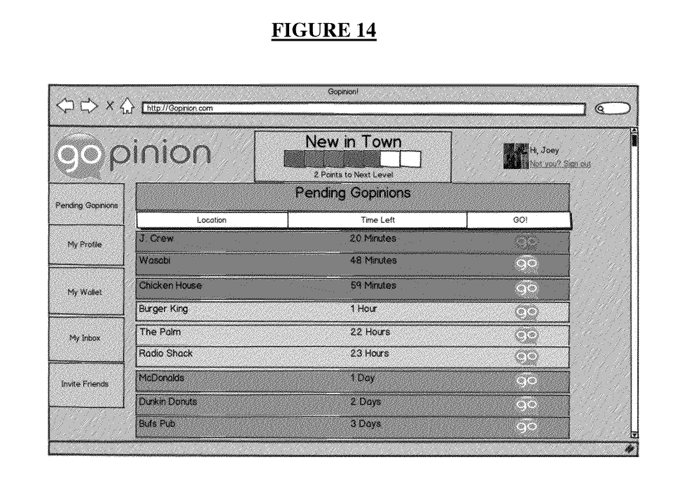

Just like in the mobile app, this page, for example, FIG. 14, will hold Micro-Surveys, or “Gopinions” that were begun, e.g., scanned, but not completed. They will stay in this section for a given period, e.g., 3 days, before disappearing.

My Profile

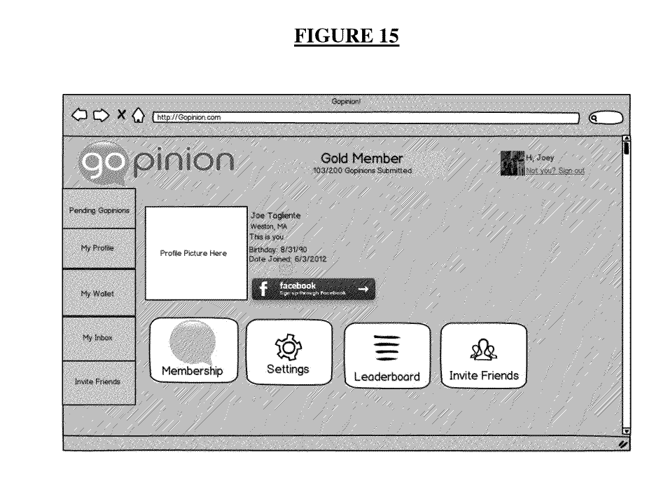

Just as in the mobile app, this page, for example, FIG. 15, will allow the consumer to personalize their account, see a few key usage stats, and check recently used deals. Also, the consumer will be able to connect through their social media pages, e.g., Facebook and twitter, from this page:

My Wallet

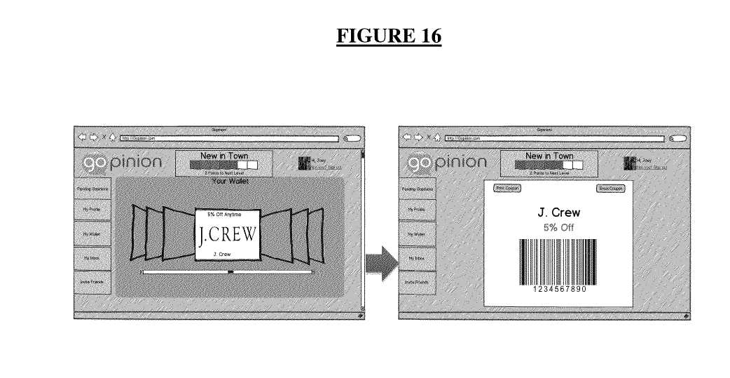

For example, FIG. 16, allows the consumer to view and manage offers. From this page the consumer will be allowed to print coupons or send them to their email:

Invite Friends

The web app will use the same “Invite Friends” screen as in the mobile app.

ii. User Specific Elements

Certain elements of the Gopinion Application are structured for the user. In one embodiment, the user facing app will only be a web app. In another embodiment the user facing app is be optimized for mobile/tablet browsing. In a user facing app the buttons and information are arranged in a “Dashboard.”

### User/Business Facing Web Application: Dashboard Elements

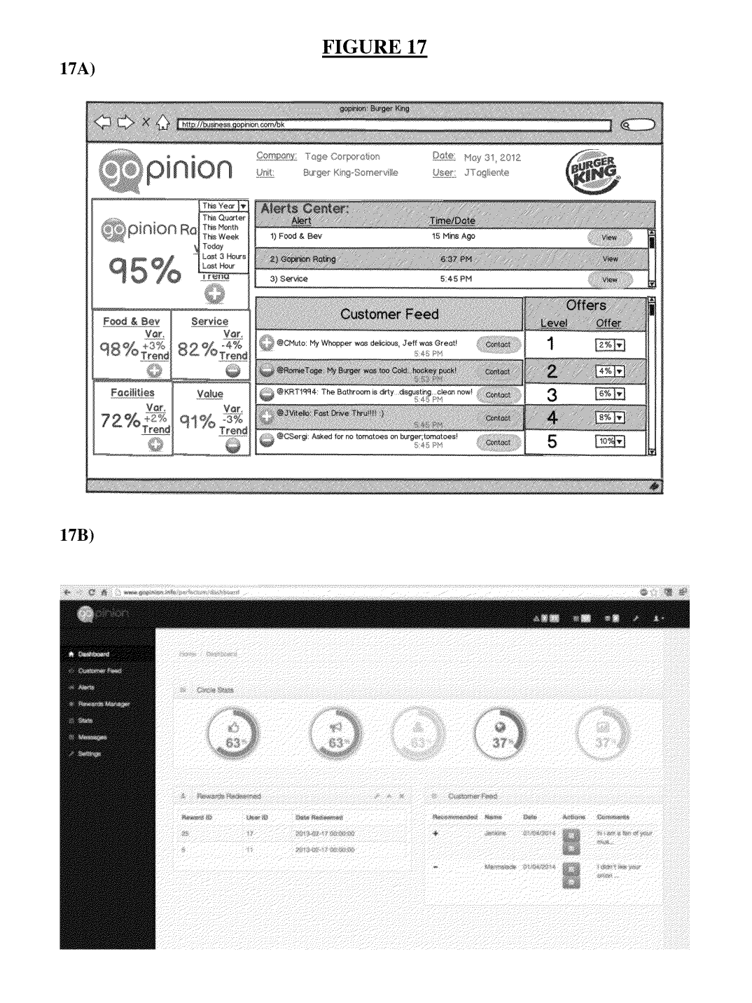

The user needs to be able to garner the most important bits of information about the way the business is currently running by a quick review of the Dashboard. In certain embodiments the Dashboard is live-updating. The components are shown in the FIGS. 17A and 17B.

The overall rating, or the gopinion rating based on the data obtained from the Micro-Surveys completed by the consumers, is prominently displayed. These gopinion numbers can be set on a scale from 0-100 to give the gopinion score in a readable, at-a-glance number for the user.

Customer Feed

The Customer Feed, for example, FIG. 17 opens up a live stream of gopinions, or gopinion surveys, coming in from the restaurants. Each gopinion will give the user/business the opportunity to contact the consumer who submitted it, via email. In certain embodiments, the user may also or alternatively contact the consumer via social media, e.g., Facebook, or via phone. It also gives the user the opportunity to send the consumer a special deal. This contact pop up can be accessed by clicking contact on any gopinion (e.g., from the customer feed page or the customer feed popchart in the dashboard:

Businesses/users will be able to manage the rewards they are willing to give (e.g., percentages etc.), and can also offer free things instead of percentage discounts (e.g., if McDonalds wants to offer free apple pie now as a deal).

Offers Manager

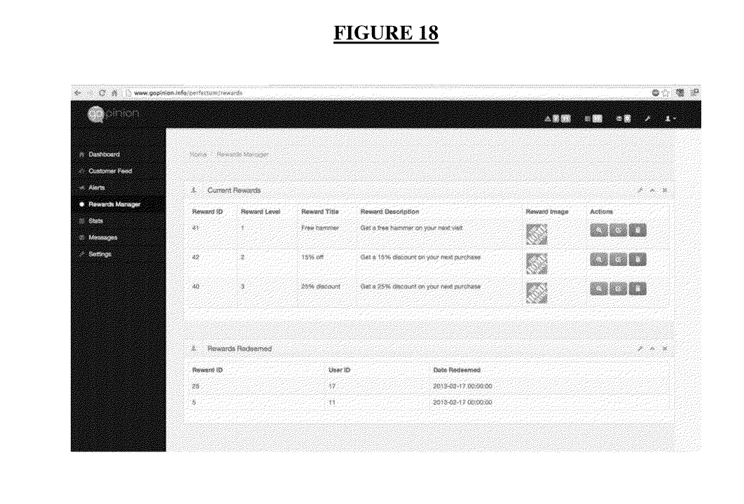

The “Office Manager,” for example, FIG. 18, is a box on the dashboard that allows the user to set their discount rates for each of the levels of user at their establishment, e.g., restaurant.

Alerts Center

The “Alerts Center” is an updating stream of alerts that the user can customize from that screen. The user will be allowed to select or unselect alerts in a specific category (e.g., gopinion rating, food & bev, service, facilities, and value) and edit the level below which they would like to be alerted. Clicking the “view” button will bring up a list of negative gopinions in the last day. Clicking any of these gopinions will bring up a page showing how that person filled out the survey, and allow the business operator/user to contact them.

Individual Popcharts

Each of the boxes on the left (gopinion rating, food & bev etc) is a clickable object that allows the user to delve deeper into the data. The individual ratings pages will show a graph of that company's performance against the market average (or another category of the user's choosing) in that category over the period of time that they select. The user will be able to toggle back and forth between the overall rating (information gathered from the first screen of binary questions) and a more in-depth look at individual response rates within the category in question (information gathered from the second screen of binary questions).

### Incorporation By Reference

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Although the heretofore description discloses example methods, articles of manufacture, apparatus and/or systems including, among other components, software executed on hardware, it should be noted that such methods, articles of manufacture, apparatus and/or systems are merely illustrative and should not be considered as limiting. For example, it is contemplated that any or all of these hardware and software components could be embodied exclusively in hardware, exclusively in software, exclusively in firmware or in any combination of hardware, firmware and/or software. Accordingly, while the following describes example methods, articles of manufacture, apparatus and/or systems, the examples provided are not the only way to implement such methods, articles of manufacture, apparatus and/or systems.

Such equivalents are considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A method of identifying the root cause of negative consumer feedback comprising the steps of
establishment of a user profile on a network;
initiation of an interface by a consumer of user goods or services;
administration of a Micro-Survey to the consumer to obtain answers to the questions of the Micro-Survey after the initiation by the consumer, wherein said Micro-Survey comprises a unified question stream (UQS) to determine a root cause of negative consumer feedback with an initial set of 1 to 5 binary questions in root cause analysis format, followed by a secondary set of 1 to 3 binary questions in root cause format dynamically selected based upon identification of negative feedback for one of the answers by the consumer to said initial set of questions;
storage of said user associated answers of the consumer in a consumer profile on the network;
combination of said answers from said consumer profile with each additional user associated answer from each additional consumer to establish a total user data set;
storage of said total user data set in the user profile;
application of statistical analysis to the total user data set to identify the root cause of negative feedback; and
outputting a root cause of the negative consumer feedback based on the final user data set and storage of the root cause in the user profile, such that the root cause of the negative feedback is identified.

2. The method of claim 1, wherein the establishment of a user profile comprises the steps of
interfacing with a user over a network;
collecting binary question from said user directed to consumer feedback;
storing said binary questions on the network; and
selecting one, two, three, four or five of said stored questions to create the Micro-Survey from said questions.

3. The method of claim 2, wherein interfacing with a user over a network is accomplished by using the internet over a mobile device.

4. The method of claim 2, wherein interfacing with a user over a network is accomplished by using the internet over a computer.

5. The method of any one of claims 1 to 4, wherein the initiation of the interface by the consumer is accomplished by launching an application on a smartphone.

6. The method of claim 5, wherein the smartphone application requests input of a readable code scan or an alphanumeric code.

7. The method of claim 6, wherein the readable code scan or alphanumeric code input identifies the geographic location of the consumer.

8. The method of claim 5 or 6, wherein the GPS in the smartphone identifies the geographic location of the consumer.

9. The method of any one of claims 6 to 8, wherein a readable code for scanning is located at the bottom of the consumer receipt, folio or invoice for goods or services of the user.

10. The method of any one of claims 6 to 8, wherein the act by the consumer of scanning the readable code administers the Micro-Survey for said user to the consumer.

11. The method of any one of claims 1 to 10, wherein the binary questions are answered by indicating a checkmark symbol for a positive response or an X symbol for a negative response based on the consumer experience with the goods or services of the user.

12. The method of any one of claims 1 to 11 further comprising the step of requesting additional comment, wherein the request is optional for the consumer to answer

13. The method of any one of claims 1 to 12 further comprising the step of offering a reward for answering all the questions of the Micro-Survey, wherein such reward would be selected and stored in the profile of the consumer.

14. The method of claim 13, wherein the reward is for the product or services of the user.

15. The method of claim 13, wherein the reward is for the product or services of another user.

16. The method of claim 13, 14, or 15, wherein the reward is selected from the group consisting of promotional items, coupons, rebates, discounts, and special offerings on goods and/or services.

17. The method of claims 1-16, wherein application of the statistical analysis to the total user data set is based on the propensity of the consumer established in the consumer profiles,

18. The method of claim 17, wherein more statistical significance is given to consumer profiles that do not provide negative feedback greater than 50% of the time.

19. The method of claim 17, wherein less statistical significance is given to consumer profiles that provide negative feedback greater than 50% of the time

20. The method of claim 17, wherein the statistical analysis is performed by using the following formula:
$${\sum }_{i = 0}^{r} {R}_{i} - {\sum }_{i = 0}^{n} {N}_{i}$$
wherein
for each consumer a consumer recommendation factor (CRF) is calculated as the number of positive answers divided by the total number of Micro-Surveys completed;
for each consumer a consumer negativity factor (CNF) is calculated using the equation: 1-CRF;
R is the set of CNFs of r users who submitted positive answers, and Rᵢ is the CNF of the i^{th} member in set R; and
N is the set of CRF's of n users who submitted negative answers, and Nᵢ is the CRF of the i^{th} member in set N.

21. The method of any one of claims 1 to 20, wherein the ability to identify the root cause of negative consumer feedback is enhanced.

22. The method of claim 21, wherein the enhancement is due to a factor selected from the group consisting of increased consumer participation, increased root cause analysis accuracy, increased statistical significance of root cause, and increased consumer compliance.

23. A method of consumer propensity (CP) weighted survey analysis comprising the steps of:
administration of a survey to a plurality of consumers of goods or services to obtain answers to the questions of the survey; and
statistical analysis of said answers, wherein the statistical analysis is calculated by using the following formula:
$${\sum }_{i = 0}^{r} {R}_{i} - {\sum }_{i = 0}^{n} {N}_{i}$$
wherein
for each consumer a consumer recommendation factor (CRF) is calculated as the number of positive answers divided by the total number of Micro-Surveys completed;
for each consumer a consumer negativity factor (CNF) is calculated using the equation: 1-CRF;
R is the set of CNFs of r users who submitted positive answers, and Rᵢ is the CNF of the i^{th} member in set R; and
N is the set of CRF's of n users who submitted negative answers, and Nᵢ is the CRF of the i^{th} member in set N.

24. The method of claim 23, wherein the survey comprises binary questions.

25. The method of claim 23, wherein the survey is a Micro-Survey.

26. The method of claim 25, wherein said Micro-Survey comprises a unified question stream (UQS) to determine a root cause of negative consumer feedback with an initial set of 1 to 5 binary questions in root cause analysis format, followed by a secondary set of 1 to 3 binary questions in root cause format dynamically selected based upon identification of negative feedback for one of the answers by the consumer to said initial set of questions.

27. A consumer survey tool comprising a machine readable medium having instructions stored thereon for execution by a processor to perform a method comprising the steps of
establishment of a user profile on a network;
initiation of an interface by a consumer of user goods or services;
administration of a Micro-Survey to the consumer to obtain answers to the questions of the Micro-Survey after the initiation by the consumer, wherein said Micro-Survey comprises a unified question stream (UQS) to determine a root cause of negative consumer feedback with an initial set of 1 to 5 binary questions in root cause analysis format, followed by a secondary set of 1 to 3 binary questions in root cause format dynamically selected based upon identification of negative feedback for one of the answers by the consumer to said initial set of questions;
storage of said user associated answers of the consumer in a consumer profile on the network;
combination of said answers from said consumer profile with each additional user associated answer from each additional consumer to establish a total user data set;
storage of said total user data set in the user profile;
application of statistical analysis to the total user data set to identify the root cause of negative feedback; and
outputting a root cause of the negative consumer feedback based on the final user data set and storage of the root cause in the user profile, such that the root cause of the negative feedback is identified.

28. The consumer survey tool of claim 27, wherein the instructions stored on the machine-readable medium are mobile application software.

29. The consumer survey tool of claim 27, wherein the instructions stored on the machine-readable medium are online software.

30. The consumer survey tool of claim 29, wherein the software is an online application.

31. The consumer survey tool of claim 30, wherein the software is a web-based application.

32. The consumer survey tool of claim 30, wherein the software is a cloud-based application.

33. The consumer survey tool of any one of claims 27 to 32, wherein the machine-readable medium is selected from the group consisting of magnetic media, optical disks, and solid state devices.

34. The consumer survey tool of any one of claims 27 to 33, wherein the establishment of a user profile comprises the steps of
interfacing with a user over a network;
collecting binary question from said user directed to consumer feedback;
storing said binary questions on the network; and
selecting one, two, three, four or five of said stored questions to create the Micro-Survey from said questions.

35. The consumer survey tool of claim 34, wherein interfacing with a user over a network is accomplished by using the internet over a mobile device.

36. The consumer survey tool of claim 34, wherein interfacing with a user over a network is accomplished by using the internet over a computer.

37. The consumer survey tool of any one of claims 27 to 36, wherein the initiation of the interface by the consumer is accomplished by launching an application on a smartphone.

38. The consumer survey tool of claim 37, wherein the smartphone application requests input of a readable code scan or an alphanumeric code.

39. The consumer survey tool of claim 38, wherein the readable code scan or alphanumeric code input identifies the geographic location of the consumer.

40. The consumer survey tool of claim 37 or 38, wherein the GPS in the smartphone identifies the geographic location of the consumer.

41. The consumer survey tool of any one of claims 38 to 40, wherein the readable code for scanning is located at the bottom of the consumer receipt, folio or invoice for goods or services of the user.

42. The consumer survey tool of any one of claims 38 to 40, wherein the act by the consumer of scanning the readable code administers the Micro-Survey for said user to the consumer.

43. The consumer survey tool of any one of claims 27 to 42, wherein the binary questions are answered by indicating a checkmark symbol for a positive response or an X symbol for a negative response based on the consumer experience with the goods or services of the user.

44. The consumer survey tool of any one of claims 27 to 43 further comprising the step of requesting additional comment, wherein the request is optional for the consumer to answer

45. The consumer survey tool of any one of claims 27 to 44 further comprising the step of offering a reward for answering all the questions of the Micro-Survey, wherein such reward would be selected and stored in the profile of the consumer.

46. The consumer survey tool of claim 45, wherein the reward is for the product or services of the user.

47. The consumer survey tool of claim 45, wherein the reward is for the product or services of another user.

48. The consumer survey tool of claim 45, 46, or 47, wherein the reward is selected from the group consisting of promotional items, coupons, rebates, discounts, and special offerings on goods and/or services.

49. A consumer survey tool employing consumer propensity (CP) weighted analysis comprising a machine readable medium having instructions stored thereon for execution by a processor to perform a method comprising the steps of:
administration of a survey to a plurality of consumers of goods or services to obtain answers to the questions of the survey; and
statistical analysis of said answers, wherein the statistical analysis is calculated by using the following formula:
$${\sum }_{i = 0}^{r} {R}_{i} - {\sum }_{i = 0}^{n} {N}_{i}$$
wherein
for each consumer a consumer recommendation factor (CRF) is calculated as the number of positive answers divided by the total number of Micro-Surveys completed;
for each consumer a consumer negativity factor (CNF) is calculated using the equation: 1-CRF;
R is the set of CNFs of r users who submitted positive answers, and Rᵢ is the CNF of the i^{th} member in set R; and
N is the set of CRF's of n users who submitted negative answers, and Nᵢ is the CRF of the i^{th} member in set N.

50. The consumer survey tool of claim 49, wherein the instructions stored on the machine-readable medium are mobile application software.

51. The consumer survey tool of claim 49, wherein the instructions stored on the machine-readable medium are online software.

52. The consumer survey tool of claim 49, wherein the software is an online application.

53. The consumer survey tool of claim 52, wherein the software is a web-based application.

54. The consumer survey tool of claim 52, wherein the software is a cloud-based application.

55. The consumer survey tool of any one of claims 49 to 54, wherein the machine-readable medium is selected from the group consisting of magnetic media, optical disks, and solid state devices.

56. The consumer survey tool of claim 49, wherein the survey comprises binary questions.

57. The consumer survey tool of claim 49, wherein the survey is a Micro-Survey.

58. The consumer survey tool of claim 57, wherein said Micro-Survey comprises a unified question stream (UQS) to determine a root cause of negative consumer feedback with an initial set of 1 to 5 binary questions in root cause analysis format, followed by a secondary set of 1 to 3 binary questions in root cause format dynamically selected based upon identification of negative feedback for one of the answers by the consumer to said initial set of questions.

59. A method of enhancing root cause analysis of negative consumer feedback by increasing consumer compliance comprising the step of
administration of a Micro-Survey to a consumer to obtain answers to the questions of the Micro-Survey, wherein said Micro-Survey comprises a unified question stream (UQS) to determine a root cause of negative consumer feedback with an initial set of 1 to 5 binary questions in root cause analysis format, followed by a secondary set of 1 to 3 binary questions in root cause format dynamically selected based upon identification of negative feedback for one of the answers by the consumer to said initial set of questions,
such that consumer compliance is increased, and the root cause analysis is enhanced.

60. The method of claim 59, wherein the enhancement is due to a factor selected from the group consisting of increased consumer participation, increased root cause analysis accuracy, increased statistical significance of root cause, and increased consumer compliance.
